(19) United States
(12) Patent Application Publication
(10) Pub. No.: US 2005/0092536 A1
(43) Pub. Date: May 5, 2005

(54) Battery holding mechanism in industrial vehicle

(76) Inventor: Mitsumasa Takeda, Kariya-shi (JP)

Correspondence Address: Morgan & Finnegan, L.L.P., 3 World Financial Center, New York, NY, 10281-2101, US

(21) Appl. No.: 10/973,716

(22) Filed: Oct. 26, 2004

(30) Foreign Application Priority Data
Oct. 31, 2003 (JP) 2003-371392

(51) Int. Cl. B60R 16/04

(52) U.S. Cl. 180/68.5

(57) ABSTRACT

A battery holding mechanism in an industrial vehicle that has a vehicle body includes a battery compartment provided adjacent to a driver's platform for installing a battery for accommodation therein from an opening formed in a side surface of the vehicle body. Also, the battery holding mechanism includes a battery stopper and a stopper operating member. The battery stopper is located adjacent to the opening for blocking the opening to hold the battery in the battery compartment and for opening the opening to allow the battery to be taken out from the battery compartment. A stopper operating member moves in conjunction with the battery stopper when the battery stopper opens the opening, such that at least a part of the stopper operating member is exposed to the driver's platform.

### BACKGROUND OF THE INVENITON

The present invention relates to a battery holding mechanism in an industrial vehicle, more particularly to a battery holding mechanism in an industrial vehicle in which a battery is installed from the side surface of a vehicle body for accommodation.

Some industrial vehicles are equipped with a battery for traveling and other purposes. As shown in FIG. 8, a battery-powered forklift truck 60 includes front wheels 61, rear wheels 62 and a counterweight 64 in the rear of a truck body 63. A battery B is installed into the truck body 63 for accommodation from a side of the truck body 63, and the forklift truck 60 further includes a battery holding mechanism 65 for holding the battery B in the truck body 63. An opening 66 is formed in the side surface of the truck body 63, and the battery B is installed into the truck body 63 through the opening 66. The battery holding mechanism 65 prevents the battery B from coming out from the truck body 63. Furthermore, when changing the battery B, the battery holding mechanism 65 is operated such that the battery B is taken out from the truck body 63 or it is installed into the truck body 63.

FIG. 9 is a side view of the battery holding mechanism 65 as viewed from the inside of the truck body 63. In the battery holding mechanism 65, a stopper holder 68 is fixed to a front panel 67, and a battery stopper 70 is connected to the stopper holder 68 via a support pin 69 so as to pivot on the support pin 69 up and down as indicated by the arrow in FIG. 9. The battery stop 70 has a locking pin 71 that is urged downward. When the battery stopper 70 is tilted at a position to block the opening 66, the locking pin 71 is inserted from above into a locking hole 72a of a locking plate 72 provided at the base portion of the battery stopper 70.

When opening the opening 66, the locking pin 71 is pulled up from the locking hole 72a, and the battery stopper 70 is turned toward the side of the front panel 67 such that the battery stopper 70 is shifted to its upright position as indicated by chain double-dashed line in FIG. 9. Thus, the battery B can be taken out from or installed in place in the truck body 63 through the opening 66. (e.g. pages 4 and 5 and FIGS. 1 through 4 in Japanese Unexamined Patent Application Publication No. 2000-219093)

In the above prior art, however, it is necessary to check the position of the battery stopper for making sure whether the battery stopper is blocking or opening the opening. Thus, it is necessary in either state to make clear the position of the battery stopper.

### SUMMARY OF THE INVENTION

The present invention provides a battery holding mechanism in an industrial vehicle in which the state of a battery stopper is recognized positively through an element other than the battery stopper, as well as by checking the position of the battery stopper.

According to the present invention, a battery holding mechanism in an industrial vehicle that has a vehicle body includes a battery compartment provided adjacent to a driver's platform for installing a battery for accommodation therein from an opening formed in a side surface of the vehicle body. Also, the battery holding mechanism includes a battery stopper and a stopper operating member. The battery stopper is located adjacent to the opening for blocking the opening to hold the battery in the battery compartment and for opening the opening to allow the battery to be taken out from the battery compartment. A stopper operating member moves in conjunction with the battery stopper when the battery stopper opens the opening, such that at least a part of the stopper operating member is exposed to the driver's platform.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a perspective view of a small-sized towing tractor according to a first preferred embodiment of the present invention;

FIG. 2 is a partially cutaway plan view of the small-sized towing tractor viewed from above according to the first preferred embodiment of the invention;

FIG. 3 is a perspective view showing a battery holding mechanism when a battery stopper blocks an opening according to the first preferred embodiment of the present invention;

FIG. 4 is a perspective view showing the battery holding mechanism when the battery stopper opens the opening according to the first preferred embodiment of the present invention;

FIG. 5 is a perspective view showing an indicating portion of the battery holding mechanism according to the first preferred embodiment of the present invention;

FIG. 6 is a side view showing a battery holding mechanism according to a second preferred embodiment of the present invention;

FIG. 7 is a perspective view showing a battery holding mechanism when a battery stopper opens an opening according to an alternative embodiment of the present invention;

FIG. 8 is a side view of a battery forklift truck including a battery holding mechanism according to prior art; and

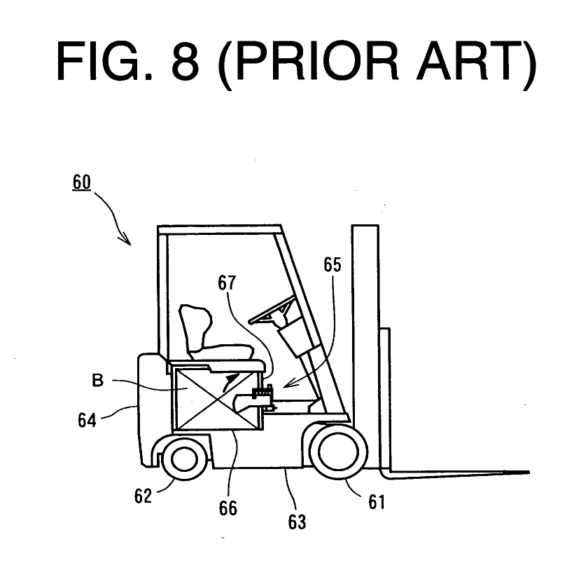

FIG. 9 is a side view of the battery holding mechanism viewed from the inside of a truck body according to the prior art.

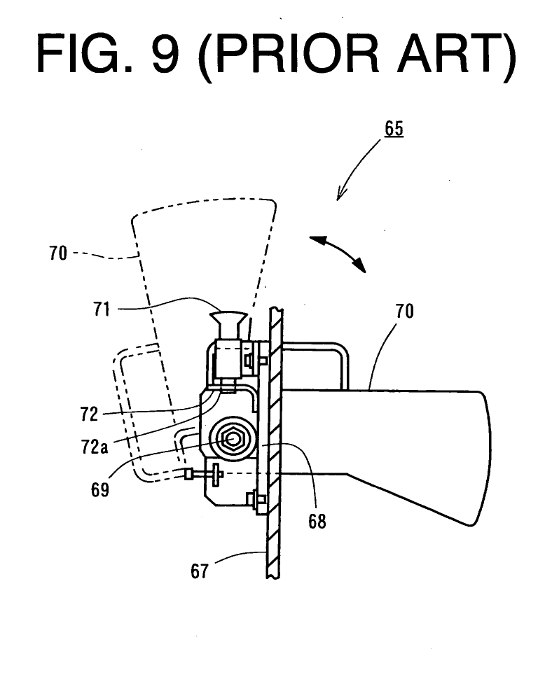

### DETAILED DESCRIPTION OF THE PREFERRED EMBODIMENTS

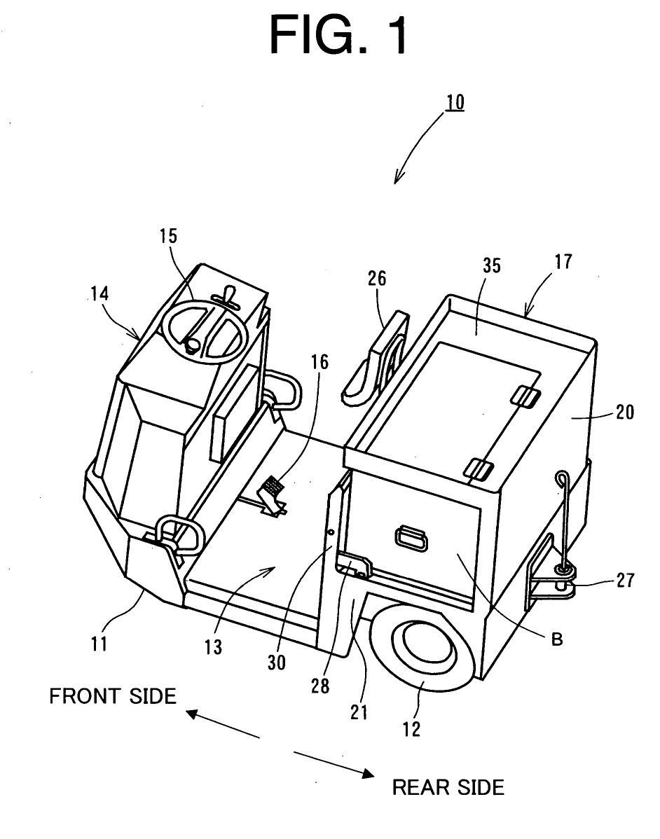

The following describes a battery holding mechanism in an industrial vehicle according to a first preferred embodiment of the present invention with reference to FIGS. 1 through 4. The battery holding mechanism of the first preferred embodiment is applied to a small-sized battery-powered towing tractor 10 as shown in FIG. 1. The small-sized towing tractor 10 as an industrial vehicle according to the first preferred embodiment will be roughly described in the following. The small-sized towing tractor 10 is a three-wheeled vehicle including one front wheel and two rear wheels (only one rear wheel 12 being shown in FIG. 1). The towing tractor 10 further includes a vehicle body 11, a driver's platform 13 arranged in the middle of the vehicle body 11, a steering wheel 15 provided at a front body 14 positioned in the front of the driver's platform 13, and a brake pedal 16 provided on the body floor in the driver's platform 13.

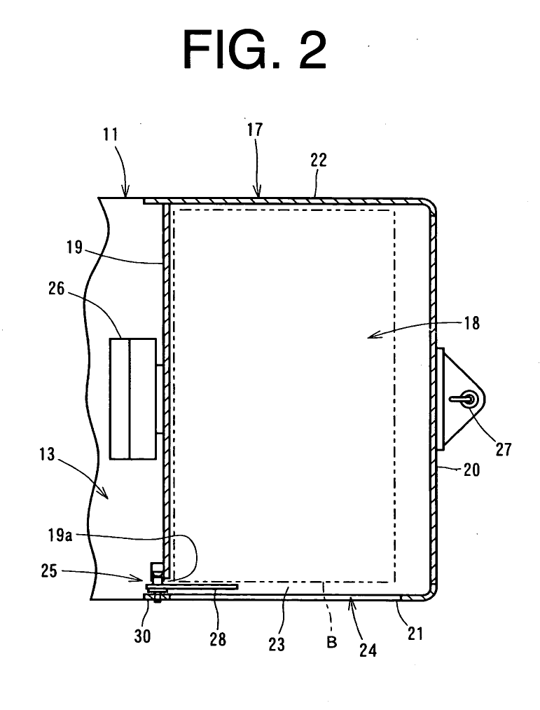

A box shaped rear body 17 is arranged behind the driver's platform 13. As shown in FIG. 2, the rear body 17 includes a battery compartment 18 for accommodating therein a battery B. The battery compartment 18 is defined by a front panel 19, a rear panel 20, side panels 21, 22, a bottom panel 23 and a top panel 35 (refer to FIG. 1). An opening 24 is formed in the side panel 21 on a side (a near side in FIG. 1) of the rear body 17 for installing or removing the battery therethrough. A battery holding mechanism 25, which will be described later, is provided at the rear body 17 adjacent to the driver's platform 13, which allows installation of the battery B into the rear body 17 from the side surface of the rear body 17 and holds the battery B in place in the rear body 17. A driver's seat 26 is provided on the front panel 19 of the rear body 17 for supporting the vehicle driver around his lower back. A hitching member 27 is provided adjacent to the bottom of the rear surface of the rear body 17 for towing. The hitching member 27 is connected to a vehicle to be towed by the towing tractor 10.

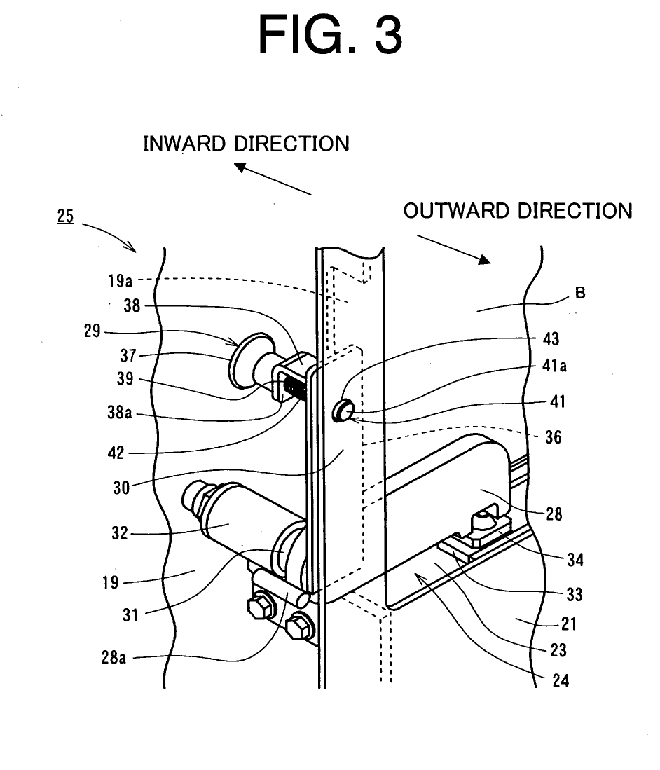

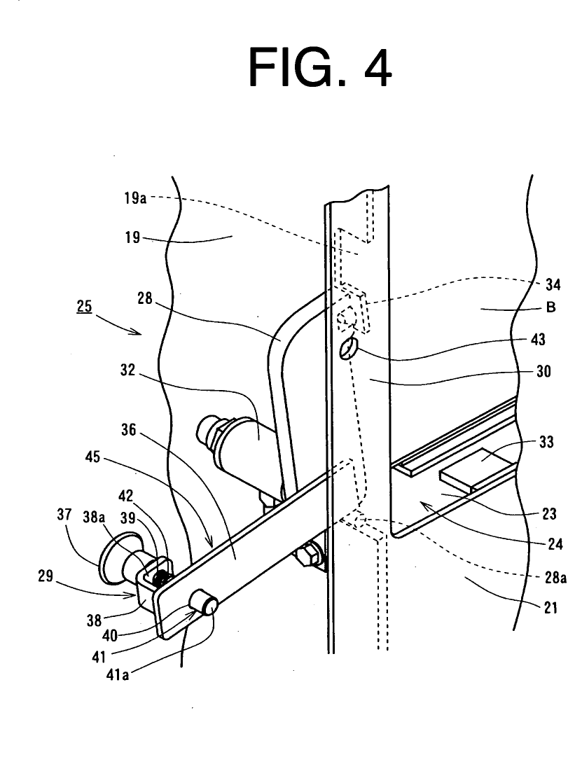

The battery holding mechanism 25 will be described more in detail with reference to FIGS. 3 and 4. The battery holding mechanism 25 includes a battery stopper 28 for blocking the opening 24 to hold the battery B in the battery compartment 18 and opening the opening 24 to allow the battery B to be taken out from the battery compartment 18, a stopper operating member 29 for operating the battery stopper 28, and a stopper support member 30 provided adjacent to the opening 24 on the side of the driver's platform 13.

The battery stopper 28 of the first preferred embodiment has a plate shape. A pivotal shaft 31 protrudes inwardly from the base portion of the battery stopper 28 in a substantially perpendicular relation to the plane of the battery stopper 28. A bracket 32 is attached to the front panel 19 of the rear body 17 adjacent to the opening 24, and the pivotal shaft 31 is supported by the bracket 32 in such a way that the battery stopper 28 is tiltable so as to block and open the opening 24. A notch 19a is formed in the front panel 19 adjacent to the opening 24 for allowing the battery stopper 28 to pass therethrough.

A contact member 33 is provided on the bottom panel 23 adjacent to the opening 24. A shock absorbing member 34 is attached to the end portion of the battery stopper 28 for contacting the contact member 33 when the battery stopper 28 is positioned to block the opening 24. The shock absorbing member 34 is provided to prevent the development of noise caused by contacting between the battery stopper 28 and the rear body 17. Meanwhile, a locking member 28a is fixed to the base portion of the battery stopper 28. When the battery stopper 28 is turned to the position to open the opening 24, the locking member 28a contacts the front panel 19 thereby to regulate the excessive turning of the battery stopper 28.

The stopper operating member 29 is connected to the base portion of the battery stopper 28 such that the stopper operating member 29 and the battery stopper 28 form a L-shaped tilt body. The stopper operating member 29 includes an elongated operating arm 36 and an operating knob 37 provided at the distal end portion of the operating arm 36. The battery stopper 28 is swung by handling the operating knob 37 provided at the operating arm 36. The operating knob 37, together with a shaft 41 and a coil spring 42, which will be described later, functions as a stopper holding means for holding the position of the battery stopper 28 when it is positioned to block the side surface of the battery B.

The operating knob 37 will be described more in detail. An L-shaped bracket 38 is attached to the inner side of the distal end portion of the operating arm 36 in such a way that a surface 38a of the bracket 38 is set in parallel to the plane of the operating arm 36. A hole 39 is formed in the bracket 38 through its parallel surface 38a. A through hole 40 is formed through the operating arm 36 in coaxial relation to the through hole 39. Meanwhile, the shaft 41 is connected to the operating knob 37, and a coil spring 42 as an elastic member is installed over the shaft 41. The shaft 41 is formed with an end portion 41a for preventing the coil spring 42 from being removed from the shaft 41.

The operating knob 37 is located on the inner side of the parallel surface 38a of the bracket 38, and the shaft 41 is inserted through the through holes 39 and 40 to extend through the parallel surface 38a of the bracket 38 and the operating arm 36. The coil spring 42 is located between the parallel surface 38a of the bracket 38 and the operating arm 36. Thus, the coil spring 42 urges the shaft 41 outward of the towing vehicle 10. The shaft end portion 41a comes in and out through the through hole 40 at the outer side of the operating arm 36 by inwardly pulling and releasing the operating knob 37.

As described already, in the first preferred embodiment, the opening 24 is formed in the side panel 21 that is located on the side surface of the rear body 17. The side panel 21 has an elongated part (designated by 30) extending vertically between the opening 24 and the driver's platform 13, as viewing the rear body 17 from a side of the opening 24 or as seen most clearly in FIG. 1.

In the first preferred embodiment, this elongated part of the side panel 21 serves as the stopper support member 30. A through hole 43 is formed through the stopper support member 30 at such a position that the hole 43 is coaxial with the hole 40 when the operating arm 36 is located on the inner side of the stopper support member 30.

When the operating arm 36 is positioned upright in overlapping relation to the inner side of the stopper support member 30, the end portion 41a of the shaft 41 connected to the operating knob 37 is inserted through the through hole 43, thereby holding the battery stopper 28 in its blocking position, as shown in FIG. 3. Thus, the stopper holding means of the first preferred embodiment includes the operating knob 37, the shaft 41, the coil spring 42 and the through hole 43 of the stopper support member 30.

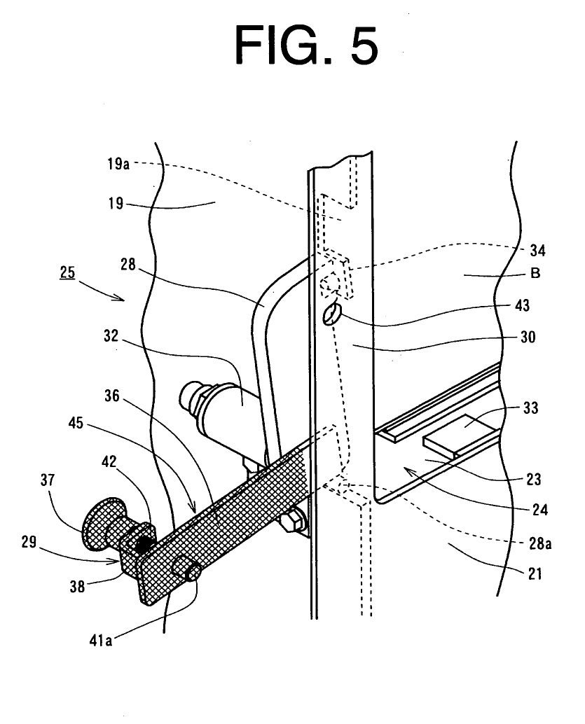

In the first preferred embodiment, it is so constructed that the state of the battery stopper 28 is recognized positively and readily by checking the state of the stopper operating member 29. With the battery stopper 28 positioned to block the opening 24, a part of the stopper operating member 29 is substantially hidden by the stopper support member 30 as viewed from the side of the side panel 21. In the first preferred embodiment, the hidden part of the stopper operating member 29 is colored by a conspicuous color as indicated by hatching in FIG. 5, and such portion is referred to as conspicuous portion 45 of the stopper operating member 29. Specifically, a part of the operating arm 36, the operating knob 37, the bracket 38 and the shaft 41 are colored conspicuously as shown by hatching in FIG. 5. When the battery stopper 28 is positioned to open the opening 24, the stopper operating member 29 is exposed to the driver's platform 13 and the conspicuous portion 45 thereof appears, accordingly. The appearance of the conspicuous portion 45 indicates the state that the battery stopper 28 opens the opening 24.

The following will describe the operation of the battery holding mechanism 25 of the first preferred embodiment. Firstly, the state where the battery stopper 28 blocks the opening 24 will be described. When the battery stopper 28 is positioned to block the opening 24, the battery stopper 28 protrudes substantially horizontally rearward. In this state, the shock absorbing member 34 of the battery stopper 28 is in contact with the contact member 33 of the bottom panel 23. The operating arm 36 of the stopper operating member 29 is in its upright position, and the shaft end portion 41a of the shaft 41 connected to the operating knob 37 is inserted through the through hole 43. Therefore, when viewed from the side of the side panel 21, the stopper operating member 29 is positioned upright in overlapping relation to the stopper support member 30, so that the stopper operating member 29 is hidden by the stopper support member 30. The position of the battery stopper 28 for blocking the opening 24 is held securely. Thus, even if the vehicle body 11 wobbles, the battery stopper 28 is kept at the blocking position and will not open the opening 24.

The case where the battery stopper 28 opens the opening 24 will be described now. Firstly, the operating knob 37 is pulled inwardly to disengage the end portion 41a of the shaft 41 from the through hole 43. With the operating knob 37 kept pulled inwardly, the operating arm 36 is turned toward the driver's platform 13 such that the battery stopper 28 stands upright. While the operating arm 36 is being turned toward the driver's platform, the battery stopper 28 stands upright. If the battery stopper 28 is turned further than its upright position or 90-degree position relative to a horizontal, the battery stopper 28 and the operating arm 36 tend to pivot on the pivotal shaft 31 further toward the driver's platform 13 due to their own weights. However, the locking member 28a contacts the front panel 19 while the operating arm 36 is turned toward the driver's platform 13, so that the operating arm 36 is kept substantially in a horizontal state and the battery stopper 28 is substantially in the upright state. In such state, part of the operating arm 36, the operating knob 37, the bracket 38 and the shaft 41 are located on the side of the driver's platform 13. Therefore, when viewed from the side of the side panel 21, the colored conspicuous portion 45 is exposed to the driver's platform 13, so that it is possible for the vehicle driver to recognize that the battery stopper 28 is positioned to open the opening 24 by checking for the exposure of the conspicuous portion 45.

The following advantageous effects are achieved according to the battery holding mechanism 25 of the first preferred embodiment.

(1) In addition to the position of the battery stopper 28, the state of the battery stopper 28 is positively recognized by checking whether or not the stopper operating member 29 is exposed to the driver's platform 13.

(2) Since the stopper operating member 29 includes the conspicuous portion 45, the appearance and the hiding of the conspicuous portion 45 make it clearer whether or not the stopper operating member 29 is exposed to the driver's platform 13. Thus, the state of the battery stopper 28 is recognized with more certainly.

(3) When the battery stopper 28 is positioned to block the opening 24, this position of the battery stopper 28 is held securely by the operating knob 37 and the shaft 41 both of which serve as the stopper holding means. Thus, even if the battery stopper 28 is exposed to vibration and shock caused by traveling of the towing tractor 10, the battery stopper 28 will not be moved thereby to open the opening 24.

(4) When the battery stopper 28 is positioned to open the opening 24, the operating arm 36 of the stopper operating member 29 protrudes out toward the driver's platform 13. Thus, the stopper operating member 29 then serves as an element for preventing the driver from getting easily on and off the towing tractor 10. Consequently, the state that the battery stopper 28 is positioned to open the opening 24 is recognized by the vehicle driver who feels such element when he gets on or off the towing tractor 10.

(5) The battery stopper 28 is located inside the stopper support member 30 of the side panel 21. Thus, even when contact or collision occurs at the side surface of the towing tractor 10, the battery stopper 28 is protected against damage by the side panel 21.

A second preferred embodiment will be now described. It is noted that, for the sake of description, some reference numerals used in the above-described first preferred embodiment will be used in the following description about the second preferred embodiment. The descriptions common to the first and second embodiments are omitted.

A battery holding mechanism 50 of the second preferred embodiment includes a changeover switch 51 that switches between energization and de-energization of a drive source 54 provided in the towing tractor 10 for traveling the towing tractor 10. When the battery stopper 28 is positioned to open the opening 24, the drive source 54 is de-energized by the changeover switch 51, thereby rendering the towing tractor 10 inoperable to travel. On the other hand, when the battery stopper 28 is positioned to block the opening 24, the drive source 54 is energized by the changeover switch 51 and the towing tractor 10 becomes operable to travel, according.

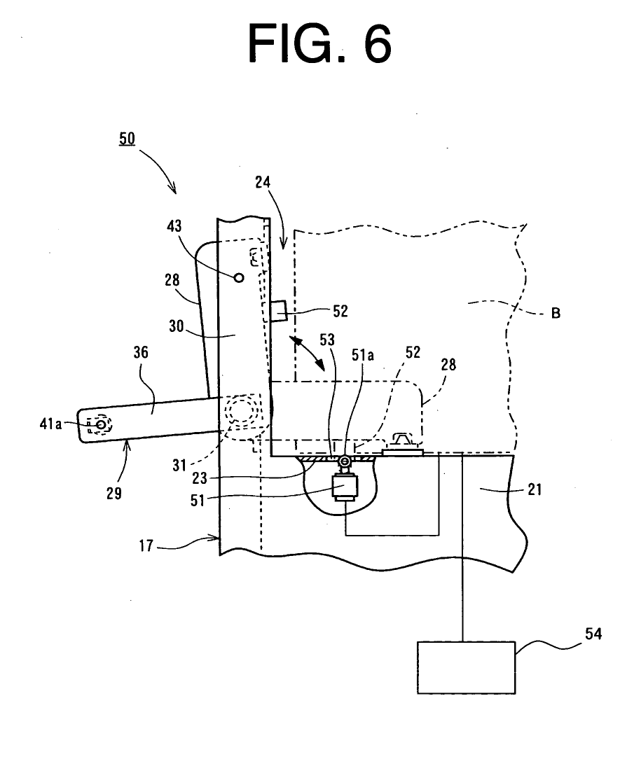

Referring to FIG. 6, the changeover switch 51 is provided inside the side panel 21 and is located beneath the bottom panel 23 at a position that corresponds to the battery stopper 28. A through hole 53 is formed through the bottom panel 23 at a position immediately above the changeover switch 51. The changeover switch 51 includes a roller 51a that is urged upward. When the roller 51a is pressed downward against the urging force, the changeover switched 51 is turned ON and sends out a signal to the battery B for energizing the drive source 54. While the roller 51a is not pressed, the changeover switch 51 is in OFF state and the drive source 54 remains de-energized.

A pressing member 52 is attached to the battery stopper 28 for pressing the roller 51a of the changeover switch 51 when the battery stopper 28 is positioned to block the opening 24. The pressing member 52 is formed so as not to prevent the battery B from passing through the opening 24 when the battery stopper 28 opens the opening 24. With the end portion 41a of the shaft 41 connected to the operating knob 37 inserted through the through hole 43 of the stopper support member 30, the roller 51a of the switch 51 is kept pressed by the pressing member 52 and the switch 51 is maintained in its ON state, accordingly.

As is apparent from the above description, when the battery stopper 28 does not block the opening 24, the drive source 54 is de-energized, thus making it certain that the vehicle body 11 is unable to travel while the opening 24 is open. According to the battery holding mechanism 50 of the second preferred embodiment, since the switch 51 is kept OFF while the battery stopper 28 is positioned to open the opening 24, the towing tractor 10 is prevented positively from running without blocking the opening 24 by the battery stopper 28.

The present invention is not limited to the above-described preferred embodiments, but various modifications are possible according to the present invention. The following alternative embodiments may be practiced.

The battery is accommodated in the rear body of the vehicle in the above-described first and second preferred embodiments. However, the battery holding mechanism of the invention is applicable to a vehicle as far as the battery compartment of the vehicle is provided adjacent to the driver's platform.

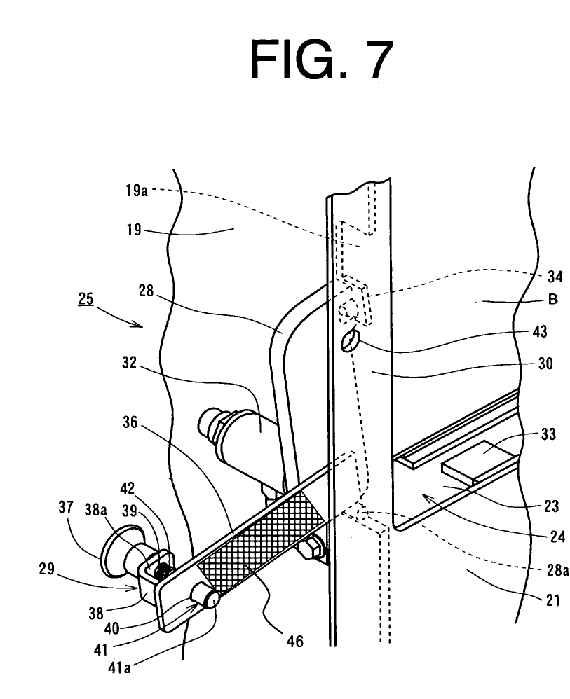

The conspicuous portion of the stopper operating member is colored by a conspicuous color in the above-described first preferred embodiment. However, instead of coloring the conspicuous portion, a luminescent or light emitting member 46 as the conspicuous portion is provided at the stopper operating member as shown in FIG. 7. In this embodiment, the state of the battery stopper is recognizable even in the darkness.

The operating arm of the stopper operating member is of an elongated plate shape in the above-described first and second preferred embodiments. It is preferable that the operating arm is substantially hidden inside the stopper support member in overlapping relation to the stopper support member when the battery stopper is positioned to block the opening. The operating arm may take any shape or structure as far as it performs the function of an operating arm of the present invention.

The conspicuous portion is provided at the stopper operating member in the above-described first preferred embodiment. According to the present invention, however, an additional conspicuous portion may be provided at the battery stopper. In this embodiment, the state of the battery stopper is recognizable by means of two elements, that is, the battery stopper and the stopper operating member.

In the above-described second preferred embodiment, the changeover switch including the roller is located beneath the bottom panel, and the roller is pressed by the pressing member of the battery stopper. However, as far as the changeover switch remains ON when the battery stopper is positioned to block the opening, the kind and the location of the switch or means for switching are not limited to that of the second preferred embodiment.

The present examples and embodiments are to be considered as illustrative and not restrictive, and the invention is not to be limited to the details given herein but may be modified within the scope of the appended claims.

1. A battery holding mechanism in an industrial vehicle including a vehicle body, a battery compartment being provided adjacent to a driver's platform for installing a battery for accommodation therein from an opening formed in a side surface of the vehicle body, comprising:
a battery stopper located adjacent to the opening for blocking the opening to hold the battery in the battery compartment and for opening the opening to allow the battery to be taken out from the battery compartment; and
a stopper operating member moving in conjunction with the battery stopper when the battery stopper opens the opening, such that at least a part of the stopper operating member is exposed to the driver's platform.

2. The battery holding mechanism according to claim 1, further comprising a stopper support member located between the opening and the driver's platform, the stopper operating member being positioned upright in overlapping relation to an inside of the stopper support member when the battery stopper blocks the opening.

3. The battery holding mechanism according to claim 1, wherein at least a part of the stopper operating member includes a conspicuous portion that indicates an opening state of the battery stopper when the stopper operating member is exposed to the driver's platform.

4. The battery holding mechanism according to claim 3, wherein the stopper operating member includes an operating arm having an elongated plate shape and an operating knob provided at an end portion of the operating arm, a part of the operating arm and the operating knob corresponding to the conspicuous portion.

5. The battery holding mechanism according to claim 3, wherein the conspicuous portion is colored by a conspicuous color.

6. The battery holding mechanism according to claim 3, wherein a luminescent member as the conspicuous portion is provided at the stopper operating member.

7. The battery holding mechanism according to claim 1, further comprising a stopper holding means for holding the battery stopper when the battery stopper blocks the opening.

8. The battery holding mechanism according to claim 7, wherein a stopper support member having a through hole is located between the opening and the driver's platform, the stopper operating member including an operating knob, a shaft being connected to the operating knob, the stopper holding means including the through hole, the operating knob and the shaft.

9. The battery holding mechanism according to claim 8, wherein the stopper holding means includes a coil spring installed over the shaft for urging the shaft in an outward direction of the industrial vehicle.

10. The battery holding mechanism according to claim 1, wherein a drive source for traveling the industrial vehicle is provided in the industrial vehicle, a changeover switch being provided for switching between energization and de-energization of the drive source by blocking and opening the opening by the battery stopper.

11. The battery holding mechanism according to claim 1, wherein the stopper operating member is connected to the battery stopper to form an L-shaped tilt body.
